(19) United States
(12) Patent Application Publication
(10) Pub. No.: US 2012/0316848 A1
(43) Pub. Date: Dec. 13, 2012

(54) SPH FLUID SIMULATION METHOD AND SYSTEM FOR MULTI-LEVEL VORTICITY, RECORDING MEDIUM FOR THE SAME

(75) Inventors: Junyong Noh, Daejeon (KR); Taekwon Jang, Daejeon (KR)

(73) Assignee: KOREA ADVANCED INSTITUTE OF SCIENCE AND TECHNOLOGY, Daejeon (KR)

(21) Appl. No.: 13/489,052

(22) Filed: Jun. 5, 2012

(30) Foreign Application Priority Data
Jun. 13, 2011 (KR) 10-2011-0056909

(51) Int. Cl. G06G 7/57; G06F 17/10

(52) U.S. Cl. 703/2

(57) ABSTRACT

Provided are a sub-particle scale turbulence simulation method for SPH fluid, and a system and recording medium for the method. In the present disclosure, by combining a multi Eulerian grid with a SPH system, various Eulerian grids are combined with the SPH system while the vorticity of particles is efficiently calculated, which allows firm detection of a deformation region. For this reason, along with the flexibility and simplicity of the multiple grids system, the present disclosure may be easily expanded to a broad spectrum in aspects of time and space. Moreover, the present disclosure may express multi-level vorticity, which could not be expressed by an existing SPH system, and give a stable and visually satisfactory result.

### CROSS-REFERENCE TO RELATED APPLICATIONS

This application claims priority under 35 U.S.C. §119 to Korean Patent Application No. 10-2011-0056909, filed on Jun. 13, 2011, in the Korean Intellectual Property Office, the disclosure of which is incorporated herein by reference in its entirety.

### TECHNICAL FIELD

The following disclosure relates to SPH fluid simulation method and system and a recording medium for the same, and in particular, to SPH fluid simulation method and system for multi-level vorticity and a recording medium for the same.

### BACKGROUND

The vortical motion of fluid is frequently observed in reality or computer animations. For example, a water stream, water pouring onto a glass, a river stream or the like is included in such eddies of fluid. In addition to the vorticity, a fluid stream often turns into turbulence which shows disordered motions.

### SUMMARY

The present disclosure is directed to providing a SPH fluid simulation method for multi-level vorticity.

The present disclosure is also directed to providing a SPH fluid simulation system for multi-level vorticity.

In one general aspect, the present disclosure provides a smoothed particle hydrodynamics (SPH) fluid simulation method for multi-level vorticity, which includes: approximating a momentum equation for the SPH fluid; generating multi-level grids having a plurality of grid cells, each level having a different resolution from another level, according to a particle velocity of the SPH fluid calculated by the momentum equation to analyze the SPH fluid as the multi-level vortical motion; detecting a hybrid deformation by calculating a change of the particles in order to detect a deformed cell having particle deformation among a plurality of grid cells in each level; calculating a cell rate of the multi-level vorticity by using multiple grids for each deformed cell, and estimating a vorticity field in each level of the multi-levels by using the calculated cell rate; and accumulating the vorticity field of each level, coupling the vorticity fields as a multi-level vorticity field, and applying vorticity confinement to each particle so that the multi-level vorticity field is enhanced and simulated.

The momentum equation may be approximated to the following equation on the assumption that each of a plurality of particles in the SPH fluid individually carries a physical quantity having a mass, a density and a pressure:

$$〈 {ρ}_{i} 〉 \frac{\partial {v}_{i}}{\partial t} = - 〈 ∇ p 〉 ( {x}_{i} ) + μ 〈 Δ v 〉 ( {x}_{i} ) + {f}_{i}^{ext}$$

where i (i is a natural number) represents a particle, xᵢ represents a particle location, vᵢ represents a velocity, p represents a pressure, μ represents a viscosity coefficient, and fᵢ^{ext} represents a gravity, a force defined by a user, or an external force such as vortices confinement forces, and where <ρᵢ>, <∇ p> and <Δv> respectively represent interpolation kernels based on approximation of a density field, a pressure field and a viscous force field at a location (xᵢ).

The pressure field may be approximated to the following equation by applying a predictive-corrective incompressible SPH (PCISPH) method:

$$〈 ∇ p 〉 ( {x}_{i} ) = - {m}^{2} {\sum }_{j} ( \frac{{p}_{i}}{{ρ}_{i}^{2}} + \frac{{p}_{j}}{{ρ}_{j}^{2}} ) ∇ {W}_{ij}$$

where Wᵢⱼ=W(xᵢ(t)−xⱼ(t)), and pᵢ is a pressure of the particle.

The pressure of the particle may be updated by repeatedly solving a predictive-corrective method according to the following equation:

pᵢ+σ(ρᵢ*−ρ₀)

where ρᵢ* represents an estimated density, a represents a scaling variable, and Σ₀ represents a rest density.

In the generating of the multi-level grids, the number of levels of the multi-level grids and ratios between levels may be determined by a user, and the generated grids correspond to multiple spatial sub-samplings of the domain.

In the generating of the multi-level grids, the multi-level grids may be generated by using an Eulerian MAC grid, and a cell size (dᵢ) and a time interval (tᵢ) of a grid in each level are determined to satisfy the following equation according to a Courant-Friedrichs-Lewy (CFL):

$$\frac{u \cdot Δ {t}_{i}}{Δ {d}_{i}} \leq {k}_{cfl} ,$$

In addition, a difference (Δdᵢ) between the cell sizes (dᵢ) and a difference (Δtᵢ) between the time intervals may be calculated by the following equation:

$$Δ {d}_{i} = {( \frac{1}{r} )}^{j - i} Δ {d}_{j}$$

$$Δ {t}_{i} = {( \frac{1}{r} )}^{j - i} Δ {t}_{j}$$

where i<j ≦n, u represents a velocity, and k_{cfl} represents a system parameter.

The detecting of the hybrid deformation may includes: performing a local eigen-analysis for each of the grid cells; and calculating the change of particles of each of the grid cells in X, Y and Z axes by applying a principle component analysis (PCA) to the particles of each of the grid cells.

The performing of the local eigen-analysis may include: encoding a deformation of each particle based on the grid cell by calculating a covariance matrix (Cov^{l}) for the grid cell according to the following equation on the assumption that a cell of a coordinate (i, j, k) has a center position (c^{l}) and the number (n) of particles (p) in each level (l) of the multi-level grid; and

$${Cov}^{l} ( i , j , k ) = {[ \begin{matrix}{p}_{1} - {c}^{l} \\ {p}_{2} - {c}^{l} \\ … \\ {p}_{n} - {c}^{l}\end{matrix} ]}^{T} [ \begin{matrix}{p}_{1} - {c}^{l} \\ {p}_{2} - {c}^{l} \\ … \\ {p}_{n} - {c}^{l}\end{matrix} ]$$

checking whether an eigen value λₘ (m ∈ {0, 1, 2}) of the covariance matrix (Cov^{l}) is a real number so that the deformed cell is detected.

In the calculating of the change of particles, the degree of deformation (D^{l}) of each the grid cell (c^{l}) may be quantified according to the following equations:

$$\frac{Δ {V}^{l}}{Δ {t}^{l}} = \sqrt{{\sum }_{m = 0}^{2} {( {λ}_{m}^{t} - {λ}_{m}^{t - 1} )}^{2}}$$

$$and$$

$${D}^{l} ( i , j , k ) = \vert \frac{Δ {V}^{l}}{Δ {t}^{l}} \vert \geq {k}_{deform}$$

where V^{l} is a total dispersion of particles of the grid cell (c^{l}) in each level (l).

The estimating of the vorticity field may include: calculating a cell rate (u) of each deformed cell according to the following equation:

$$u ( i , j , k ) = {\sum }_{i} ( \frac{{d}_{i} {v}_{i}}{\sum {d}_{i}} )$$

where vᵢ is a velocity of the particle, and dᵢ is a distance between the particle and the center of the cell; and estimating a vorticity field (ω^{l}) in each level (l) of the multi-level grid by means of a curl operation based on a finite difference method (FDM) applied to the calculated velocity field (u^{l}).

The enhancing and simulating of the multi-level vorticity field may include: accumulating a vorticity field (ω¹) of each level according to the following equation to be obtained as a kind of the multi-level vorticity field;

ω=Σₗω^{l}=Σₗ(∇×u^{l})

calculating a particle vorticity (ωᵢ) by applying a trilinear interpolation method to the multi-level vorticity field; calculating a vorticity confinement force of each particle according to the following equation:

$${f}_{vorticity} = ɛ ( N \times \frac{{ω}_{i}}{\vert {ω}_{i} \vert} ) {ρ}_{i}$$

where ε is a user parameter and the vorticity location (N) is N=(p_{⊕}−pᵢ)/|p_{⊕}−pᵢ| which is a center of mass p_{⊕} of two SPH particles; and applying the vorticity confinement force to the multi-level vorticity field.

In the SPH fluid simulation method for multi-level vorticity and the system and recording medium for the same according to the present disclosure, by combining the multi Eulerian grid with the SPH system, various Eulerian grids are combined with the SPH system while the vorticity of particles is efficiently calculated, which allows firm detection of a deformation region. For this reason, along with the flexibility and simplicity of the multiple grids system, the present disclosure may be easily expanded to a broad spectrum in aspects of time and space. Moreover, the present disclosure may express multi-level vorticity, which could not be expressed by an existing SPH system, and give a stable and visually satisfactory result.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 shows the concept of a SPH fluid simulation method for multi-level vorticity according to the present disclosure;

FIG. 2 illustrates the SPH fluid simulation method for multi-level vorticity according to the present disclosure;

FIG. 3 shows an instantly captured image simulated according to the SPH fluid simulation method for multi-level vorticity according to the present disclosure;

FIG. 4 shows an example of a hybrid deformation detection process on a deformation region in a multi-level; and

FIG. 5 comparatively shows simulation results according to an existing SPH simulation method and the SPH fluid simulation method for multi-level vorticity according to the present disclosure.

### DETAILED DESCRIPTION OF EMBODIMENTS

In order to sufficiently understand the present disclosure, advantages in operations of the present disclosure and objects accomplished by the implementation of the present disclosure, accompanying drawings which exemplarily show preferred embodiments of the present disclosure and contents depicted in the accompanying drawings should be referred to.

Hereinafter, preferred embodiments of the present disclosure will be described with reference to the accompanying drawings to illustrate the present disclosure in detail. However, the present disclosure may be implemented in various different ways, without being limited to the following embodiments. In addition, in order to clearly describe the present disclosure, explanations extrinsic to the essential features of the present disclosure will be omitted, and the same reference symbol in the drawings represents the same component.

In the entire specification, when expressing that any part “includes” a component, it means that the part can further include another component, without excluding other components, if not otherwise indicated. In addition, the terms such as “ . . . unit”, “ . . . portion”, “module” and “block” used in the specification means a unit which performs at least one function or operation, and it can be implemented as a hardware or software, or a combination thereof.

In order to capture a vorticity motion to have an excellent visual effect, it is very important to analyze vorticity of various scales. However, it is substantially difficult that a turbulence having a wide spectrum in the velocity scale is captured through a numerical simulation to have a sense of realism. For example, high resolution demands spatial discretization which requires a high calculation cost.

The calculation cost may be efficiently reduced by applying an adaptive approach technique to the simulation. However, if a system using the adaptive approach technique depends only on an Eulerian or Lagrangian approach technique, it is difficult to simulate a multi-level vorticity to a sufficient level. Therefore, an Eulerian grid based system often applies a more accurate numerical method or utilizes an adaptive grid structure in order to overcome the difficulty of the simulation.

However, the scale required for analyzing a small vortical motion is often smaller than a cell size of the adaptive grid, and the numerical dispersion effect of the small scale cannot be neglected.

Similarly, the Lagrangian particle system may selectively increase the number of sampling particles in a region of interest such as regions near a free surface or around an object. However, the existing techniques are just focused on the spatial adaptiveness, and do not seriously consider a long-term effect such as large scale eddies frequently observed in water streams. Intrinsically, due to the Lagrangian characteristic of particles, it is difficult to define the time clustering operation for spatio-temporal adaptiveness. This limit makes the existing adaptive technique be inappropriate in simulating a vorticity motion of fluid. In addition, even though an adaptive sampling technique is applied, the artificial viscosity effect caused by the interpolation operation is still present in the smoothed particle hydrodynamics (SPH) system.

In addition, the Lagrangian particle has a problem in that it is not easy to accurately determine a location of an eddy to be reinforced or preserved and the degree of reinforcement or preservation. For example, in an existing vorticity particle method, a particle having an initial random vorticity is sprayed to a user-designated region in a specific frame. The vorticity particle may freely move in an entire domain without a special limit. However, this movement sometimes results in movement to an undesired location during conversion. Since the motion of the vorticity particle is determined by Lagrangian advection and cannot be predicted before a simulation is performed, the deformation result may not be estimated in some cases, and the deformation result may show contrivance in some regions.

As an alternative, a hybrid approach technique is applied to analyze a multi-level vorticity. The advantages of the Euler and Lagrangian methods may be combined to supplement each other. For example, a vorticity having a scale smaller than an Eulerian grid may be analyzed by a Lagrangian particle which may reduce the numerical dispersion effect in a grid system. The location and size of a vorticity may be easily determined by adopting a curl in a velocity field on the grid.

The present disclosure proposes a new method for efficiently capturing a multi-scale vortical motion in a SPH fluid based on a hybrid concept. In the present disclosure, a SPH system associated with a multi-level Eulerian grid is applied to calculate vorticity of various scales. Compared with an existing hybrid system using the Lagrangian particle system to generate small-scale details such as bubbles below the water surface or small water drops in the air and using the Eulerian grid system to handle large parts of the water, the approach method of the present disclosure uses a particle system in order to effectively analyze a multi-level vorticity.

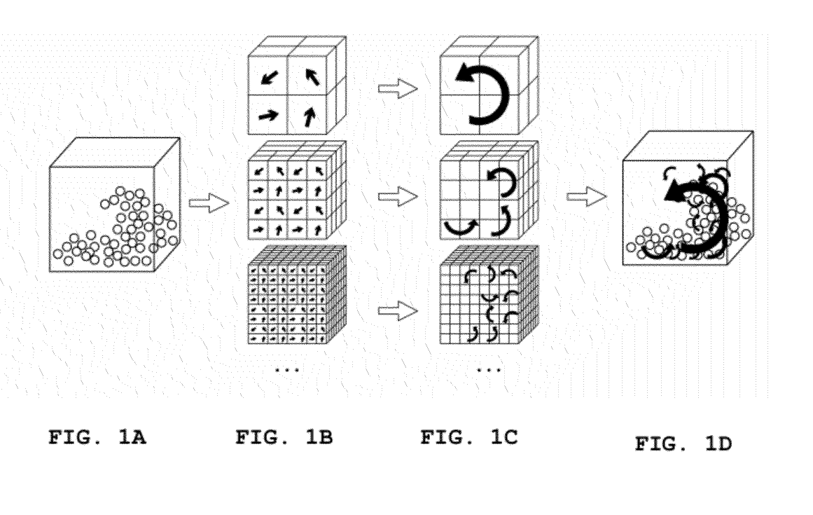

FIG. 1 shows the concept of a SPH fluid simulation method for multi-level vorticity according to the present disclosure.

Referring to FIG. 1, in the SPH fluid simulation method for multi-level vorticity according to the present disclosure, the particle velocity of the SPH system is transferred to cells in multiple grids. In FIG. 1, a portion (a) illustrates a process where the particle velocity of the SPH system is transferred to cells in multiple grids, and a portion (b) illustrates a process of calculating a vorticity at each cell by using a cell rate. In addition, a portion (c) illustrates a process where a vorticity field from each level is combined and transferred to particles in the SPH system, and a portion (d) illustrates that the multi-level particle vorticity is enhanced by applying a vorticity confinement to each particle.

In other words, in the present disclosure, the multi-level vorticity is calculated by utilizing the rule of an Eulerian grid at each level, as shown in FIG. 1. Detailed vorticity motions may be reproduced by reinforcing particles around an eddy by means of a particle-based vorticity confinement technique. In order to demonstrate that the above system effectively reproduces the multi-level vorticity of the SPH fluid, region which may be greatly deformed have vorticity motions will be proposed as examples.

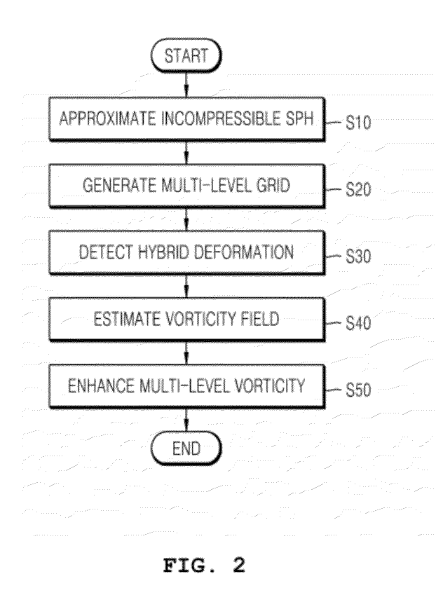

FIG. 2 shows the SPH fluid simulation method for multi-level vorticity according to the present disclosure.

Referring to FIG. 2, the SPH fluid simulation method of the present disclosure performs an incompressible SPH approximating step (S10).

As described above, in the present disclosure, a SPH system associated with a multi-level Eulerian grid is applied to calculate vorticity of various scales. In the SPH, the fluid is not considered as a set of moving particles. In other words, the SPH considers that each particle carries physical quantity such as mass, density and pressure. Therefore, the state of the SPH fluid may be obtained by approximation to a momentum equation like Equation 1.

$$〈 {ρ}_{i} 〉 \frac{\partial {v}_{i}}{\partial t} = - 〈 ∇ p 〉 ( {x}_{i} ) + μ 〈 Δ v 〉 ( {x}_{i} ) + {f}_{i}^{ext} \qquad Equation 1$$

Here, i (i is a natural number) represents a particle, xᵢ represents a particle location, vᵢ represents a velocity, p represents a pressure, μ represents a viscosity coefficient, and fᵢ^{ext} represents a gravity, a force defined by a user, or an external force such as vortices confinement forces. In addition, <ρᵢ>, <∇ p> and <Δv> respectively represent interpolation kernels based on approximation of a density field, a pressure field and a viscous force field at a location (xᵢ). In the present disclosure, isotropic kernels including a poly kernel for field interpolation, a spiky kernel for approximating a slant and a viscosity kernel for Laplacian operation, proposed in the SPH technique of Muller (Muller, M., Charypar, D., Gross, M.: Particle-based fluid simulation for interactive applications. In: Proceedings of the 2003 ACM SIGGRAPH/Eurographics symposium on Computer animation, SCA '03, pp. 154-159. Eurographics Association, Aire-la-Ville, Switzerland, Switzerland (2003)) are used.

The present disclosure applies a predictive-corrective incompressible SPH (hereinafter, PCISPH) technique (B. Solenthaler and R. Pajarola. Predictive-corrective incompressible sph. In ACM SIGGRAPH 2009 papers, SIGGRAPH “09, pages 40:1-40:6, New York, N.Y., USA, 2009. ACM.) in order to minimize the influence of a spurious bouncing motion and a numerical error during the particle simulation.

The SPH technique of Muller is a method where SPH of Desbrun and Gascuel is expanded and applies various particles such as fluid-fluid interaction, creation of bubbles, a dispersion phenomenon such as a mixture of water spray and air, and a fluid stream through porous material, based on the fluid analysis. However, due to the excessive use of equations of state (EOS), the SPH technique of Muller has a problem in that it may not easily regulate incompressibility. Therefore, various techniques such as a weakly compressible SPH (WCSPH) and a pressure corrected SPH have been proposed, and the PCISPH proposed by Solenthaler is a method for calculating the intensity of pressure.

The PCISPH technique uses an estimated pressure value in order to approximate the pressure field. Therefore, the pressure field (<∇ p>) in Equation 1 is approximated as in Equation 2.

$$〈 {∇}_{p} 〉 ( {x}_{i} ) = - {m}^{2} {\sum }_{j} ( \frac{{p}_{i}}{{ρ}_{i}^{2}} + \frac{{p}_{j}}{{ρ}_{j}^{2}} ) ∇ {W}_{ij} \qquad Equation 2$$

Here, Wᵢⱼ=W(xᵢ(t)−xⱼ(t)), and pᵢ is a pressure of the particle. In the PCISPH, a pressure value for each particle is updated by repeatedly solving the predictive-corrective technique according to Equation 3 below.

pᵢ+=σ(ρᵢ*−ρ₀) Equation 3

Here, where ρᵢ* represents an estimated density, a represents a scaling variable, and ρ₀ represents a rest density. In the present disclosure, during the test, an internal particle randomly selected is used to calculate a firstly, similar to the PCISPH. In the present disclosure, according to a fixed scaling factor (δ), the predictive-corrective step is repeated by a predetermined number (for example, three times) at each frame in order to regulate the incompressibility of the SPH fluid, similar to the PCISPPH.

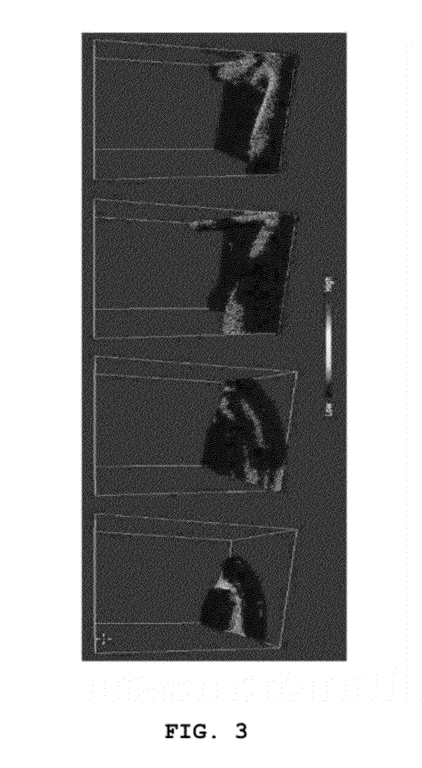

FIG. 3 shows an instantly captured image simulated according to the SPH fluid simulation method for multi-level vorticity according to the present disclosure.

FIG. 3 shows the fluid simulated according to the incompressible SPH approach, and the simulation is performed from the left to the right. In addition, the size of vorticity calculated for each particle is visually displayed using colors. In FIG. 3, the size of vorticity of each particle is expressed as a color spectrum: blue for weak vorticity and red for great vorticity.

After that, a multi-level grid generating step (S20) of FIG. 2 is performed.

In the present disclosure, in order to analyze the multi-level vorticity motion in a stable and efficient, way, a spatially uniform Eulerian MAC grid is used. In the present disclosure, particularly, several grids having different resolutions are generated. The number of levels (n) and the ratio of each level (r) are provided by a user. The generated grid corresponds to multiple spatial sub-samplings of the domain. In the highest resolution grid, the cell size equals to the SPH particle's smoothing radius, and the time interval equals to the time unit of the SPH simulation. In each grid, the cell size (dᵢ) and the time interval (tᵢ) are determined as in Equation 4 below by applying a Courant-Friedrichs-Lewy (CFL) condition to each level.

$$\frac{u \cdot Δ {t}_{i}}{Δ {d}_{i}} \leq {k}_{cfl} \qquad Equation 4$$

In addition, in Equation 4, the difference (Δdᵢ) between cell sizes (dᵢ) and the difference (Δtᵢ) between time intervals are calculated as in Equation 5.

$$Δ {d}_{i} = {( \frac{1}{r} )}^{j - i} Δ {d}_{j} \\ Δ {t}_{i} = {( \frac{1}{r} )}^{j - i} Δ {t}_{j} \qquad Equation 5$$

Here, i<j≦n, u represents a velocity, and k_{cfl} represents a system parameter. The multi cell size and time interval demand capturing vortical motions of different scales and velocities. For example, a great vortical motion using many cells may be captured at a low resolution grid having a greater cell and a greater time interval.

After the multi-level grid generating step (S20) is performed, a hybrid deformation detecting step (S30) is performed.

The SPH fluid simulation method for multi-level vorticity according to the present disclosure applies a hybrid technique which utilizes the rule of an Eulerian grid in order to supplement the SPH particle system when analyzing the multi-level vorticity. The hybrid technique is applied for detecting a deformation. Here, a particle deformation detection process is systemized as a local eigen-analysis for each grid cell, and a principle component analysis (PCA) is applied to particles in each cell to calculate the change of the particles in X, Y and Z axes of each cell.

The local eigen-analysis assumes a cell of a coordinate (i, j, k) which has a center position (c^{l}) and the number (n) of particles (p) in each level (l). Therefore, the covariance matrix (Cov^{l}) for the cell is expressed as Equation 6.

$${Cov}^{l} ( i , j , k ) = {[ \begin{matrix}{p}_{1} - {c}^{l} \\ {p}_{2} - {c}^{l} \\ … \\ {p}_{n} - {c}^{l}\end{matrix} ]}^{T} [ \begin{matrix}{p}_{1} - {c}^{l} \\ {p}_{2} - {c}^{l} \\ … \\ {p}_{n} - {c}^{l}\end{matrix} ] \qquad Equation 6$$

By Equation 6, it is possible to encode a deformation of each particle. For example, the center position (c’) may be changes as particle centric criteria such as in the centroid

$$( \overline{p} - 1 / \vert N \vert ( {\sum }_{i ∈ N} {\overline{p}}_{i} ) ) .$$

However, the particle-based deformation encoding often requires attention when treating exceptional cases such as crumbing of particles or external particles (outliers). Even though the cell-based particle deformation encoding is approximated based on low resolution, the cell-based particle deformation encoding copes with an irregular state such as the deficiency of neighboring particles in a better way in comparison to the particle-based deformation encoding. Additionally, the criteria of the centroid of different particles (local pressure ratio, the number of neighboring particles, or a combination thereof) depend on the accuracy of kernel interpolation which is weak against deformation. Further, in order to set different scenes, in a trial and error process which consumes time, it is required to determine an optimal weight for combining suitable thresholds or standards for a single criterion.

In order to detect a deformation region, an eigen value λₘ (m ∈ {0, 1, 2}) of the covariance matrix (Cov^{l}) is checked. The covariance matrix (Cov^{l}) is a 3×3 positive semi-definite matrix, where all eigen values are real numbers.

As described above, in the hybrid deformation detection technique, after the local eigen-analysis is performed, the principle component analysis is applied to particles of each cell to calculate the change of particles with respect to X, Y and Z axes of each cell.

The degree of deformation (D^{l}) for each cell (c^{l}) is quantified by using Equation 7 and Equation 8.

$$\begin{matrix}\frac{Δ {V}^{l}}{Δ {t}^{l}} = \sqrt{{\sum }_{m = 0}^{2} ( {λ}_{m}^{t} - {λ}_{m}^{t - 1} ) 2} & Equation 7 \\ {D}^{l} ( i , j , k ) = \vert \frac{Δ {V}^{l}}{Δ {t}^{l}} \vert \geq {k}_{deform} & Equation 8\end{matrix}$$

Here, V^{l} is a total dispersion of particles of the grid cell (c^{l}) in each level (l). In addition, during the time interval (Δt^{l}), the change in each axis is measured. This equation allows effective detection of a cell having a high deformation. For example, if particles move to rapidly diverge or converge, the change of dispersion in each direction may make the cell be remarkable as a deformation.

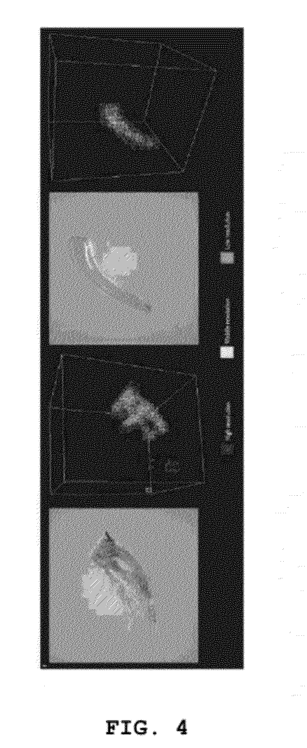

FIG. 4 shows an example of a hybrid deformation detection process on a deformation region in a multi-level. In FIG. 4, cells detected in three levels are depicted as an example, and deformation-detected cells of different levels are respectively expressed with different sizes and colors. In other words, red represents a small-sized cell having a high resolution, gray represents a middle-sized cell having a medium resolution, and blue represents a great-sized cell having a low resolution.

If the hybrid deformation detecting step (S30) is completed, a step of estimating a vorticity field in each level (S40) is performed.

If a deformed cell is found, a multi-level vorticity may be calculated by using multiple grids. The hybrid vorticity enhancement step (S40) starts with configuring a velocity field for each grid. The weighted average of particle velocities calculates a cell rate (u) as in Equation 9.

$$u ( i , j , k ) = {\sum }_{i} ( \frac{{d}_{i} {v}_{i}}{\sum {d}_{i}} ) \qquad Equation 9$$

Here, vᵢ represents a velocity of a particle, and dᵢ represents a distance between the particle and the center of the cell.

A vorticity field (ω^{l}) is estimated in each level by a simple curl operation based on a finite difference method (FDM) applied to a given velocity field (u^{l}). The curl operation is well known in the art and not described in detail here.

After that, a vorticity enhancement step (S50) is finally performed.

ω=Σₗ ω^{l}=Σₗ(∇×u^{l}) Equation 10

As in Equation 10, by accumulating multiple vorticity fields, a single vorticity field (ω) may be obtained. The particle vorticity (w₁) may be calculated by trilinear interpolation in the field. For each particle, the vorticity confinement force is calculated as in Equation 11 by using only neighboring particles.

$${f}_{vorticity} = ɛ ( N \times \frac{{ω}_{i}}{\vert {ω}_{i} \vert} ) {ρ}_{i} \qquad Equation 11$$

Here, ε is a user parameter, and the vorticity location (N) is N=(p_{⊕}−pᵢ)/|p_{⊕}−pᵢ| which is a center of mass p_{⊕} of two SPH particles.

As the calculated vorticity confinement force is applied to the vorticity field (ω), the multi-level vorticity may be enhanced and simulated.

As a result, the present disclosure approximates a vorticity according to the SPH fluid simulation technique, dissolves the approximated SPH fluid into grids of a plurality of levels having different resolutions by using an Eulerian MAC grid, and then detects a particle deformation of cells included in each dissolved grid. The degree of deformation is calculated for a deformation-detected cell of each level, and the calculated degree of deformation is expressed as a single vorticity by using multiple grids, so that the multi-level vorticity may be easily simulated.

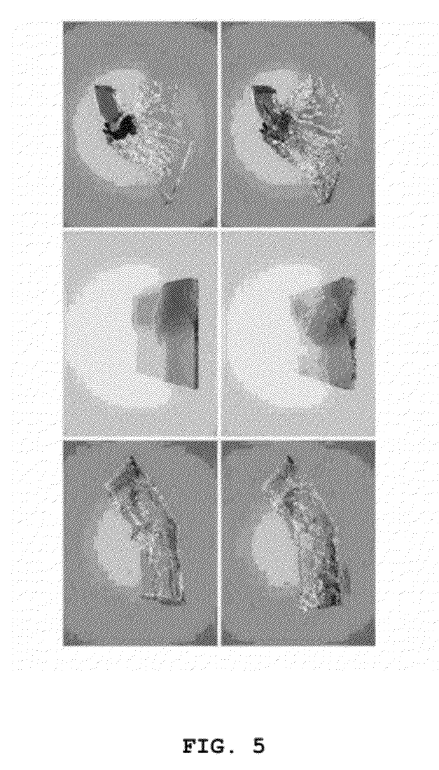

FIG. 5 comparatively shows simulation results according to an existing SPH simulation method and the SPH fluid simulation method for multi-level vorticity according to the present disclosure.

The simulation depicted in FIG. 5 is a result accomplished by a computer system having a 2.27 GHz Intel Zeon CPU and 8 gigabyte memory. In addition, a vorticity field was calculated by using uniform regular grids. Moreover, in this example, grids of three levels were used. Among grids in each level, a high resolution grid has a 42×42×42 resolution, a middle resolution grid has a 21×21×21 resolution, and a low resolution grid has an 11×11×11 resolution. In all examples, a fixed time interval of 0.002 second was set.

In FIG. 5, the top is a simulation result generated by the existing SPH simulation method, and the bottom is a simulation result generated by the SPH fluid simulation method for multi-level vorticity according to the present disclosure. In addition, a portion (a) represents an image which simulates a water stream according to object collision, a portion (b) represents an image which simulates a dam collapse state, and a portion (c) represents an image which simulates a state where water is poured into a rabbit model.

In the portion (a) of FIG. 5, the water stream sliding along a slope and colliding an object is generated from cubic particles, 84 particles being emitted per simulation frame. In this example, the number of emitted particles is exactly 25,200 in 300 frames. In both images, the water streams move similarly as a whole, but particles bounding near the border make striking differences. As the treatment on a border gives a great influence on the vorticity, in the portion (a) of FIG. 5, the vorticity is generated and enhanced at the border or corner.

The portion (b) of FIG. 5 is a simulation result of a dam collapse state, and uses 44,649 particles. In the present disclosure, as shown in the bottom of the portion (b) of FIG. 5, a surface having more deformations may be simulated. The vorticity motion may be exaggerated to some extent if a user adjusts a parameter (c), but the effect of the multi-level vorticity allows the vorticity motion to look like a natural turbulence stream. A user may adjust a user parameter (E) in order to emphasize the vorticity in a specific level or correct the effect range of vorticity. In the present disclosure, the user parameter (c) has values of 1.0, 0.15 and 0.01, for example.

In the portion (c) of FIG. 5, the scene that water is poured to the rabbit model shows the influence of multi-level vorticity at particles having thin surfaces, different from the portions (a) and (b). In the portion (c) of FIG. 5, it can be checked that the particles are scattered with more vivid multi-level vorticity after colliding the rabbit model, compared with an existing SPH simulation.

The simulation of FIG. 5 is implemented using a Compute Unified Device Architecture (CUDA) in order to maximize the use of parallel calculation. The process which occurs most frequently in the simulation and consumes most time is searching a most neighboring particle. For better efficiency, particle hashing may be applied to auxiliary grids by a radix sort algorithm. In the present disclosure, the simulation of the above test may be obtained in real time. In addition, in order to obtain velocity enhancement in a mesh generating processor, a matching cube based on CUDA according to grids (128×128×128) may be applied to perform a simulation within just several seconds.

In the present disclosure, grids are reused to calculate cell-based velocity and vorticity. The multi-level grids may have expanded auxiliary grids having different resolutions. The expanded auxiliary grids may be stored in a memory of the GPU memory as a 1-dimensional arrangement. An individual CUDA thread may be activated and executed in parallel when each cell is combined. For example, the vorticity confinement of the SPH may call CUDA threads as much as the velocity defined in each cell and the number of cells utilizing vorticity. The combination between the cell and the particle inside is registered in the GPU memory, and all frames are updated. The use of the GPU may accelerate the particle-grid combining process. Additionally, by implementing a simple kernel function to support the GPU, the performance may be further enhanced when an eigen value of a 3×3 matrix is analyzed.

As a result, the SPH fluid simulation method for multi-level vorticity according to the present disclosure proposes a new particle-grid hybrid system which efficiently reproduces a multi-level vortical motion to the SPH fluid. By combining the multi

Eulerian grid with the SPH system, various Eulerian grids are combined with the SPH system while the vorticity of particles is efficiently calculated, which allows firm detection of a deformation region. Along with the flexibility and simplicity of the multiple grids system according to the present disclosure, the present disclosure may be easily expanded to a broad spectrum in aspects of time and space.

Even though it has been described in the present disclosure that the multi-level has three levels as an example, the number of levels may be variously adjusted.

The apparatus according to the present disclosure may be implemented as computer-readable codes on a computer-readable recording medium. The computer-readable recording medium includes all kinds of recording devices which store data readable by a computer system. The recording medium is, for example, ROM, RAM, CD-ROM, magnetic tapes, floppy disks, optical data storages or the like, and may also be implemented in the form of carrier wave (for example, to be transmittable through Internet). In addition, the computer-readable recording medium may be distributed to computer systems connected through a network so that the computer-readable codes are stored and executed in a distribution way.

While the present disclosure has been described with respect to the specific embodiments, it will be apparent to those skilled in the art that various changes and modifications may be made from the present disclosure.

Therefore, the spirit and scope of the disclosure should be defined in the appended claims.

What is claimed is:

1. A smoothed particle hydrodynamics (SPH) fluid simulation method for multi-level vorticity, comprising:
approximating a momentum equation for the SPH fluid;
generating multi-level grids having a plurality of grid cells, each level having a different resolution from another level, according to a particle velocity of the SPH fluid calculated by the momentum equation to analyze the SPH fluid as the multi-level vortical motion;
detecting a hybrid deformation by calculating a change of the particles in order to detect a deformed cell having particle deformation among a plurality of grid cells in each level;
calculating a cell rate of the multi-level vorticity by using multiple grids for each deformed cell, and estimating a vorticity field in each level of the multi-levels by using the calculated cell rate; and
accumulating the vorticity field of each level, coupling the vorticity fields as a multi-level vorticity field, and applying vorticity confinement to each particle so that the multi-level vorticity field is enhanced and simulated.

2. The SPH fluid simulation method for multi-level vorticity according to claim 1, wherein the momentum equation is approximated to the following equation on the assumption that each of a plurality of particles in the SPH fluid individually carries a physical quantity having a mass, a density and a pressure:
$$〈 {ρ}_{i} 〉 \frac{\partial {v}_{i}}{\partial t} = - 〈 ∇ p 〉 ( {x}_{i} ) + μ 〈 Δ v 〉 ( {x}_{i} ) + {f}_{i}^{ext}$$
where i (i is a natural number) represents a particle, xᵢ represents a particle location, vᵢ represents a velocity, p represents a pressure, μ represents a viscosity coefficient, and fᵢ^{ext} represents a gravity, a force defined by a user, or an external force such as vortices confinement forces, and
where <ρᵢ>, <∇ p> and <Δv> respectively represent interpolation kernels based on approximation of a density field, a pressure field and a viscous force field at a location (xᵢ).

3. The SPH fluid simulation method for multi-level vorticity according to claim 2, wherein the pressure field is approximated to the following equation by applying a predictive-corrective incompressible SPH (PCISPH) method:
$$〈 ∇ p 〉 ( {x}_{i} ) = - {m}^{2} {\sum }_{j} ( \frac{{p}_{i}}{{ρ}_{i}^{2}} + \frac{{p}_{j}}{{ρ}_{j}^{2}} ) ∇ {W}_{ij}$$
where Wᵢⱼ=W(xᵢ(t)−xⱼ(t)), and pᵢ is a pressure of the particle.

4. The SPH fluid simulation method for multi-level vorticity according to claim 3, wherein the pressure of the particle is updated by repeatedly solving a predictive-corrective method according to the following equation:
pᵢ+=σ(ρᵢ*−ρ₀)
where ρᵢ* represents an estimated density, σ represents a scaling variable, and σ₀ represents a rest density.

5. The SPH fluid simulation method for multi-level vorticity according to claim 4, wherein, in said generating of the multi-level grids, the number of levels of the multi-level grids and ratios between levels are determined by a user, and the generated grids correspond to multiple spatial sub-samplings of the domain.

6. The SPH fluid simulation method for multi-level vorticity according to claim 5,
wherein, in said generating of the multi-level grids, the multi-level grids are generated by using an Eulerian MAC grid, and a cell size (dᵢ) and a time interval (tᵢ) of a grid in each level are determined to satisfy the following equation according to a Courant-Friedrichs-Lewy (CFL):
$$\frac{u \cdot Δ {t}_{i}}{Δ {d}_{i}} \leq {k}_{cfl} ,$$
wherein a difference (Δdᵢ) between the cell sizes (dᵢ) and a difference (Δtᵢ) between the time intervals are calculated by the following equation:
$$Δ {d}_{i} = {( \frac{1}{r} )}^{j - i} Δ {d}_{j}$$
$$Δ {t}_{i} = {( \frac{1}{r} )}^{j - i} Δ {t}_{j}$$
where i<j≦n, u represents a velocity, and k_{cfl} represents a system parameter.

7. The SPH fluid simulation method for multi-level vorticity according to claim 6, wherein said detecting of the hybrid deformation includes:
performing a local eigen-analysis for each of the grid cells; and
calculating the change of particles of each of the grid cells in X, Y and Z axes by applying a principle component analysis (PCA) to the particles of each of the grid cells.

8. The SPH fluid simulation method for multi-level vorticity according to claim 7, wherein said performing of the local eigen-analysis includes:
encoding a deformation of each particle based on the grid cell by calculating a covariance matrix (Cov^{l}) for the grid cell according to the following equation on the assumption that a cell of a coordinate (i, j, k) has a center position (c^{l}) and the number (n) of particles (p) in each level (I) of the multi-level grid; and
$${Cov}^{l} ( i , j , k ) = {[ \begin{matrix}{p}_{1} - {c}^{l} \\ {p}_{2} - {c}^{l} \\ … \\ {p}_{n} - {c}^{l}\end{matrix} ]}^{T} [ \begin{matrix}{p}_{1} - {c}^{l} \\ {p}_{2} - {c}^{l} \\ … \\ {p}_{n} - {c}^{l}\end{matrix} ]$$
checking whether an eigen value λₘ (m ∈ {0, 1, 2}) of the covariance matrix (Cov^{l}) is a real number so that the deformed cell is detected.

9. The SPH fluid simulation method for multi-level vorticity according to claim 8, wherein, in said calculating of the change of particles, the degree of deformation (D^{l}) of each the grid cell (c^{l}) is quantified according to the following equations:
$$\frac{Δ {V}^{l}}{Δ {t}^{l}} = \sqrt{{\sum }_{m = 0}^{2} ( {λ}_{m}^{t} - {λ}_{m}^{t - 1} ) 2}$$
$$and$$
$${D}^{l} ( i , j , k ) = \vert \frac{Δ {V}^{l}}{Δ {t}^{l}} \vert \geq {k}_{deform}$$
where V^{l} is a total dispersion of particles of the grid cell (c^{l}) in each level (l).

10. The SPH fluid simulation method for multi-level vorticity according to claim 9, wherein said estimating of the vorticity field includes:
calculating a cell rate (u) of each deformed cell according to the following equation:
$$u ( i , j , k ) = {\sum }_{i} ( \frac{{d}_{i} {v}_{i}}{\sum {d}_{i}} )$$
where vₗ is a velocity of the particle, and dₗ is a distance between the particle and the center of the cell; and
estimating a vorticity field (ω^{l}) in each level (l) of the multi-level grid by means of a curl operation based on a finite difference method (FDM) applied to the calculated velocity field (u^{l}).

11. The SPH fluid simulation method for multi-level vorticity according to claim 10, wherein said enhancing and simulating of the multi-level vorticity field includes:
accumulating a vorticity field (ω^{l}) of each level according to the following equation to be obtained as a kind of the multi-level vorticity field;
ω=Σₗ ω^{l}=Σₗ(∇×u^{l})
calculating a particle vorticity (ωᵢ) by applying a trilinear interpolation method to the multi-level vorticity field;
calculating a vorticity confinement force of each particle according to the following equation:
$${f}_{vorticity} = ɛ ( N \times \frac{{ω}_{i}}{\vert {ω}_{i} \vert} ) {ρ}_{i}$$
where ε is a user parameter, and the vorticity location (N) is N(p_{⊕}−pᵢ)/|p_{⊕}−pᵢ| which is a center of mass p_{⊕} of two SPH
particles; and
applying the vorticity confinement force to the multi-level vorticity field.

12. A computer-readable recording medium on which program instructions for simulating the multi-level vorticity by using the SPH fluid simulation method for multi-level vorticity according to claim 1 is recorded.

13. A computer system, comprising a display unit, wherein the computer system operates a program for the SPH fluid simulation method for multi-level vorticity according to claim 1, and displays and stores a simulation result.

14. A computer-readable recording medium on which program instructions for simulating the multi-level vorticity by using the SPH fluid simulation method for multi-level vorticity according to claim 2 is recorded.

15. A computer-readable recording medium on which program instructions for simulating the multi-level vorticity by using the SPH fluid simulation method for multi-level vorticity according to claim 3 is recorded.

16. A computer-readable recording medium on which program instructions for simulating the multi-level vorticity by using the SPH fluid simulation method for multi-level vorticity according to claim 4 is recorded.

17. A computer system, comprising a display unit, wherein the computer system operates a program for the SPH fluid simulation method for multi-level vorticity according to claim 2, and displays and stores a simulation result.

18. A computer system, comprising a display unit, wherein the computer system operates a program for the SPH fluid simulation method for multi-level vorticity according to claim 3, and displays and stores a simulation result.

19. A computer system, comprising a display unit, wherein the computer system operates a program for the SPH fluid simulation method for multi-level vorticity according to claim 4, and displays and stores a simulation result.
